(19) United States
(12) Patent Application Publication
(10) Pub. No.: US 2018/0032930 A1
(43) Pub. Date: Feb. 1, 2018

(54) System and method to Generate Queries for a Business Database

(71) Applicants: Kurt Robert KOLB, Burnaby (CA); Kazem JAHANBAKHSH, Vancouver (CA); Maziyar HAMDI, Vancouver (CA)

(72) Inventors: Kurt Robert KOLB, Burnaby (CA); Kazem JAHANBAKHSH, Vancouver (CA); Maziyar HAMDI, Vancouver (CA)

(73) Assignee: 0934781 B.C. Ltd, Vancouver (CA)

(21) Appl. No.: 15/730,628

(22) Filed: Oct. 11, 2017

Related U.S. Application Data
(63) Continuation-in-part of application No. 14/877,774, filed on Oct. 7, 2015.
Application No. 14/877,774 is a continuation-in-part of application No. 14/877,573, filed on Oct. 7, 2015.
(60) Provisional application No. 62/406,418, filed on Oct. 11, 2016.

(51) Int. Cl. G06Q 10/06; G06F 17/27; G06F 17/30

(52) U.S. Cl. CPC G06Q 10/0637; G06F 17/30958; G06F 17/30684; G06F 17/2785; G06F 17/274; G06F 17/278; G06Q 30/0625

(57) ABSTRACT

A method and system are provided for analyzing data in an online professional social network to identify and rank organizations with regard to providing professional services. A graph structure provides an efficient structure for accessing and processing data about service providers. The method and system provide a means to convert an unstructured query from a user into a graph query to return search results that provide a context for past provisions of services. An organization may be connected in the graph to problem and solution nodes to indicate that the organization can provide a solution to a given problem entered by a user.

### BACKGROUND

There are several online directories and marketplaces dedicated to matching buyers to service providers. The buyer may enter their requirements for the service using menu selections in a User Interface (UI). This can be a good way to search as the search values and attribute types are unambiguous and standardized. However it can be tedious to enter all fields and there is no flexibility in expressing one's search preference.

Many websites, such as Sortlist, Fiverr, Linkedin's Profinder, and Thumbtack, provide a text search box to find services using the buyer's own words. The search engines may match the words to a list of words or n-grams associated with each service. Thus text entered by a user returns either an exact match or closest matches. However, once matched, the query proceeds using the standardized terms in the system and subtleties in the original search are lost.

Additionally, many users do not know what words describe the services they need, or appreciate the meaning of some services, and indeed service providers themselves may disagree on the meaning of some services. Thus the user must sort through many bad results or keep adjusting their search terms to learn what words return a good set of results.

The search engines do not explore relationships, intent, non-vendor data, buyer's problems, or variations in services offered. The search process requires users to disambiguate, weight, and select evidence or relevant data themselves.

### SUMMARY

This summary provides a selection of aspects of the invention in a simplified form that are further described below in the detailed description. This summary is not intended to limit the claimed subject matter's scope.

According to a first aspect there is provided a computer-implemented method comprising: providing a graph comprising problem nodes representing business problems, solution nodes representing business solutions, and organization nodes representing organizations; receiving a search query about a business problem from a user device; matching the query to one or more problem nodes in the graph; identifying solution nodes connected in the graph to matched problem nodes; identifying organization nodes connected in the graph to identified solution nodes; and communicating data about certain of the identified organization nodes to the user device, as query results.

The search query may be an unstructured text query.

The method may comprise creating one or more structured queries from the unstructured text query, the one or more structured queries comprising identifiers of problem nodes and solution nodes.

The method may comprise communicating to the user device a set of Natural Language Generated suggestions from candidate problem and/or solution nodes identified from the query.

The method may comprise receiving a selection of one or more of the Natural Language Generated suggestions from the user device to indicate a user preference for corresponding business problems or business solutions.

The identified organization nodes maybe connected to the problem and/or solution nodes corresponding to the selected problems and/or selected solutions.

According to a second aspect there is provided a computer-implemented method comprising: providing a database arranged as a graph of business relationships between organizations; receiving an unstructured query from a user device; creating one or more structured graph queries from the unstructured query, using a Natural Language Processing (NLP) process, wherein each structured graph query comprises an identifier of second nodes connected by edges to one or more first nodes to be returned as search results, the nodes and edges representing a context for a provision of professional services related to the unstructured text query; and running the one or more structured graph queries on the graph to return search results to the user device, which results comprise data from the first nodes.

At least one of the first or second nodes may represent organizations providing the professional services

The other of the first or second nodes may represent one of: a document, a case study, a person, a solution, a problem or another organization.

The NLP may use Named Entity Recognition and a grammar to determine graph identifiers of nodes and edges and a query pattern.

The graph may comprise nodes corresponding to one or more of: case studies, employees, problems, and solutions.

The NLP process may use template queries to create the structured graph queries.

The method may comprise ranking the structured graph queries based on at least one of: similarity of each structured graph query to template queries; the amount of data in the graph that supports each structured graph query; similarity of each structured graph query to structured graph queries that were previously selected.

The Named Entity Recognition (NER) Module may identify organization names, location names, industry names or service names.

The results returned may be organizations that provide a professional service.

The method may comprise aggregating data of the search results, preferably segregated by the type of second node.

The method may comprise creating clusters of first or second nodes by their attributes; receiving a selection of a cluster from the user device; and displaying search results based on the selection.

According to a third aspect there is provided a computer system comprising a database arranged as a graph of business relationships between organizations; an interface for receiving an unstructured query from a user; a search engine for processing the unstructured query into words and parts of speech; creating one or more structured graph queries comprising graph identifiers and a graph query pattern; and running the structures graph queries on the graph to return first nodes as search results; and a communication process for providing the search results to the user.

The search engine may comprise a Natural Language Understanding module, Named Entity Recognition module and a grammar model.

The search engine may comprise a ranking process for ranking the nodes in the search results depending on the number of paths in the database to each node found using the one or more structured graph queries.

The search engine may further rank structured graph queries depending on one or more of: similarity of the unstructured query to template queries that correspond to the one or more structured queries; historical selections by users of each structured queries, and quantity of data in the database that supports each structured query.

Both the foregoing general description and the following detailed description provide examples and are explanatory only. Accordingly, the foregoing general description and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

FIG. 1 is an illustration of connections between software modules of servers and client devices.

FIG. 2 is a block diagram of a computer system.

FIG. 3 is an illustration of a business graph.

FIG. 4 is an illustration of a problem and solutions in a business graph.

FIG. 5 is a flowchart for matching problems and solutions.

FIG. 6 is a flowchart for creating a structured query.

FIG. 7 is a flowchart for running a structured query.

FIG. 8 is a set of inverse indexes for finding nodes

FIG. 9A-9B illustrates a webpage receiving example queries.

FIGS. 10A, 10B, 10C, 10D illustrate a conversion of an example string to a structured query.

FIG. 11 illustrates a method for extracting text to populate a database.

### DESCRIPTION

The inventors have appreciated that a suitably arranged database comprising organizations, problems, and solutions would solve many of the drawbacks of existing text search engines. The search engine disclosed here returns more precise results by considering relationships between items in the search query. In certain embodiments, the search engine returns data about vendors or case studies that are connected to an organization regarding the past provision of services.

More powerful searches and results involve a first object to be returned having at least one relevant connection to a second object, the second object and connection providing a context or evidence for the past provision of professional services, in order for the user to understand the results. The first objects may be vendor organizations or case studies. The second objects may be documents, case studies, people, solutions, problems or client organizations. Conversely most directory sites simply return the companies that themselves match the most attributes or keywords of the search. Such directory search results provide no context or evidence to show that such vendors are relevant to the query.

The present database is structured to record such connections and the query language implemented to find such connections. Advantageously this returns search results with a required path to second objects, which provides evidence and path context for the results. In this database, the second objects are connected to the first objects rather than being part of it. This provides some independence and verification for the other objects. Thus many objects can share or connect to other objects to garner evidence of relatedness to the search.

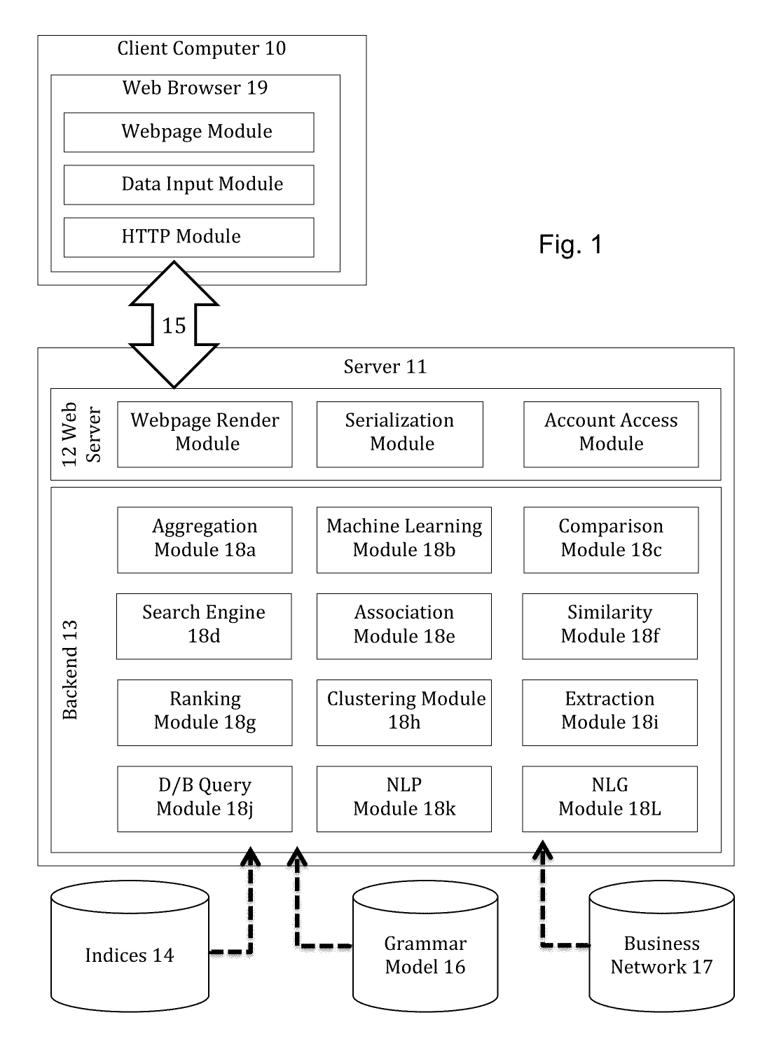

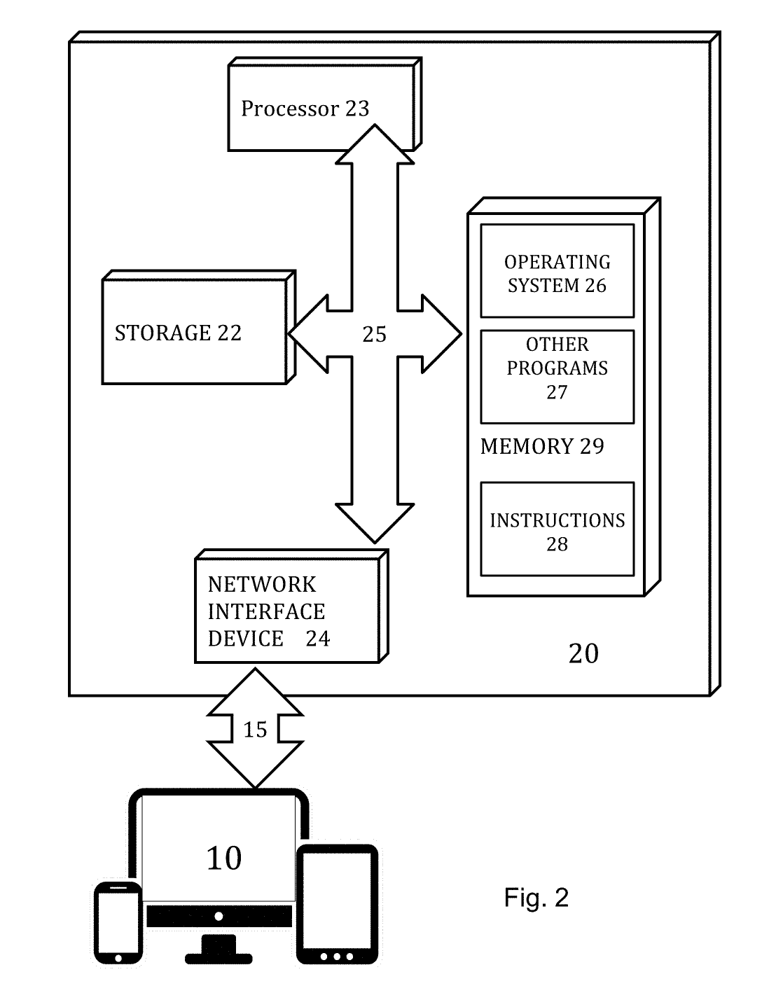

The present technology is implemented using computer systems and computer processing methods. FIG. 1 is an illustration of software modules and FIG. 2 is a block diagram of computing components provided in a system enabling searching and data processing.

FIG. 1 illustrates the interaction between user device 10 and the server 11 over network link 15. The devices 10 may communicate via a web browser 19 or smartphone APP, using software modules to receive input from the user, make HTTP requests and display data. The server 11 may be a reverse proxy server for an internal network, such that the client device 10 communicates with an Nginx web server 12, which relays the client's request to backend processes 13, associated server(s) and database(s) 14, 16 and 17. Within the server, software modules 18a-I perform functions such as, retrieve data, build and process data via service model(s), match requests and providers and calculate various score. Some software modules may operate within a notional web server 12 to manage user accounts and access, serialize data for output, render webpages, and handle HTTP requests from the device 10.

FIG. 2 is a block diagram of an exemplary computer system for creating the present system and performing methods described herein. The system 20 includes a bus 25 for connecting storage 22, non-volatile memory 29, one or more processors 23 and network interface device 24. The memory holds software instructions for the operating system 26, instructions 38 and other applications as may be needed. The network interface device communicates over the Internet connection 15 with client devices 10.

The one or more processors may read instructions from computer-readable memory 29 and execute the instructions 28 to run the methods and modules described below. Examples of computer readable media are non-transitory and include disc-based media such as CD-ROMs and DVDs, magnetic media such as hard drives, semiconductor based media such as flash media, random access memory, and read only memory.

Users may access the databases remotely using a desktop or laptop computer, smartphone, tablet, or other client-computing device 10 connectable to the server 11 by mobile internet, fixed wireless internet, WiFi, wide area network, broadband, telephone connection, cable modem, fiber optic network or other known and future communication technology using conventional Internet protocols.

The web server's Serialization Module converts the raw data into a format requested by the browser. Some or all of the methods for operating the database may reside on the server device. The devices 10 may have software loaded for running within the client operating system, which software is programmed to implement some of the methods. The software may be downloaded from a server associate with the provider of the database or from a third-party server. Thus the implementation of the client device interface may take many forms known to those in the art. Alternatively the client device simply needs a web browser and the web server 19 may use the output data to create a formatted web page for display on the client device. The devices and server may communicate via HTTP requests.

The methods and database discussed herein may be provided on a variety of computer system and are not inherently related to a particular computer apparatus, particular programming language, or particular database structure. The system is capable of storing data remotely from a user, processing data and providing access to a user across a network. The server may be implemented on a stand-alone computer, mainframe, distributed-network or cloud network. Although example structures queries are shown in a particular format herein, it will be appreciated that other formats may be used using other query languages, such as GraphQL, OpenCypher, Gremlin, or SPARQL.

### Database

The present system comprises a database preferably arranged to capture business relationships between organizations, particularly with regard to professional services. The system may be considered a business network, akin to social networks for people. The database includes different types of data object, such as, organizations, problems, solutions, case studies, awards, content, and people. Data objects may store attribute values, images, documents, and tags. The database also stores connections (aka relationships, links, associations) between two data objects.

A graph is an efficient structure to implement such a database, whereby nodes store profiles for people/organizations, content for case studies/problems/solutions and edges record the connections. The connections may be undirected (e.g. ‘similar-to’, ‘coworkers’, ‘competitors’) or directed (e.g. ‘vendor-to’ and its inverse ‘client-to’). The system may be operated as a social network, whereby users actively create connections and interact with other users.

A database system may comprise or be derived from multiple databases, possibly including third party databases. Each database may store its own graph shard to capture certain relationship types and having at least some users in common such that a database server can detect separate instances of a person on each graph, merge them, and analyze the mixed relationship modes between users across all graph shards. Sharding allows parts of a query to be divided up and run in parallel on different processors.

In the specification and drawings, an example graph implementation is shown, however, it will be appreciated that other data structures may be used to link problems to solutions to companies and documents.

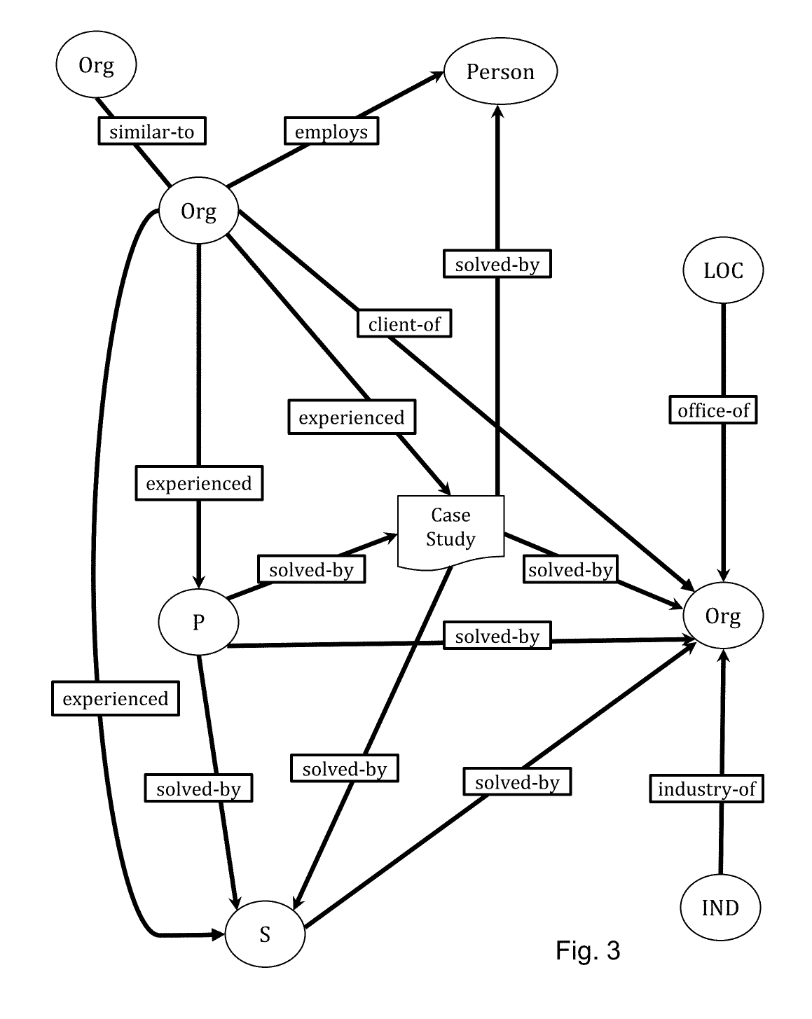

FIG. 3 shows an example graph with representative node and edge types (inverse edges are not shown here). Shown are the node types: organization (Org), location (LOC), industry (IND), problem (P), solution (S), case study and person. Connecting these nodes are the edges: solved-by, client-of, similar-to, office-of, industry-of, employs, and experienced. As shown, one edge type may be used between nodes of different types, in which case the search engine may return all the connected nodes, filter on certain node types, or separate results by node type. This allows the search to be ambiguous with regard to the node type to be returned. The node type may be discernible from a coded portion in the node ID.

In other embodiments, each pair of node types has its own edge type (e.g. organization-organization; organization-case study; problem-solution, etc.) even to record similar concepts. This makes access time faster when the node type is known.

The database structure may include the following edges (with inverse equivalents) and representations:

Employs (inverse: is-employed-by) is a directed edge from an organization node to a person node and represents that the organization employs the person in real life.

Client-of (inverse: vendor-to) is a directed edge from a first organization node to a second organization node and represents that the first organization is a client of the second in real life.

Solved-by (inverse: solves) is a directed edge from a case study node, problem node, or solution node to an organization node and represents that the organization has provided services with regard to the case study, problem, or solution. This may also be a directed edge between a case study node and a problem node or solution node to represents that the real-life case study demonstrates solving that problem using that solution.

Experienced (inverse: experienced-by) is a directed edge from an organization node to a case study node, problem node, or solution node and represents that the organization has experienced requiring services with regard to the case study, problem, or solution.

Office-in (inverse: located-at) is a directed edge from an organization node to a location (city or region) and represents that the organization has an office at that location in real life. The actual street address is stored in the organization record.

Has-industry (inverse: industry-of) is a directed edge from an organization node to an industry node and represents that the organization operates in that industry in real life. Details of its operation are stored in the organization's record.

Similar-to may be an undirected edge from a first organization node to a second organization node and represents that the first organization's firmographic data are similar to the second's. A ‘similar’ edge is useful for finding organizations having a business relationship with organizations similar to an identified organization. There may be a similar-to edge between case studies nodes representing that the cases solve similar problems using a similar solution. This edge may be calculated by the system's Similarity Module and the calculated similarity value stored with the edge.

The database may employ inverted indices for each edge type, such that the search engine can identify one or more node Ds given a starting node ID or keyword.

Attributes such as location and industry may be stored with each organization object. However, these are popular search parameters and thus it is efficient to create node types for large cities/regions and general industries. The exact office address and industry description can be stored with the organization object.

Alternatively a graph database may have native processing capabilities and index-free adjacency. Thus each node directly references its adjacent nodes, acting as a micro-index for all nearby nodes. Index-free adjacency is more efficient than using global indexes, as query times are proportional to the amount of the graph searched, rather than increasing with the overall size of the database.

### Problem And Solution Nodes

The database preferably comprises a problem data object (e.g. problem node), which represents a problem experienced by clients or solved by case-studies/vendors. The inventors have appreciated that there may be many different ways for a buyer to describe a problem and each problem may be solved with many different solutions. Without jumping straight to the solution, the system allows the buyer to express their perception of the problem in their own words. The database also comprises a solution data object (e.g. solution node), which represents a solution provided by a vendor or demonstrated by a case study. A single solution may solve many problems and a solution is not necessarily coterminous with a service attribute.

Consider the service tag, “Search Engine Optimization” (SEO). This service is offered by vendors in the industries of marketing, web design, web development, content writing, or by an SEO specialist. Each of these industries will have a different interpretation of this service. Even within an agreed meaning, SEO may be provided in many ways, such as black hat techniques, white hat techniques, content marketing, and website optimization, with each attaining different results. Thus the service tag is not as specific or meaningful as a solution object, which more precisely conveys methodologies and expected results. A vendor may be tagged with a given service attribute but only provide a subset of the related solutions and only to a subset of problems. This subtle difference improves the system by removing the need for a buyer to consider vendors that provide other solutions to other problems

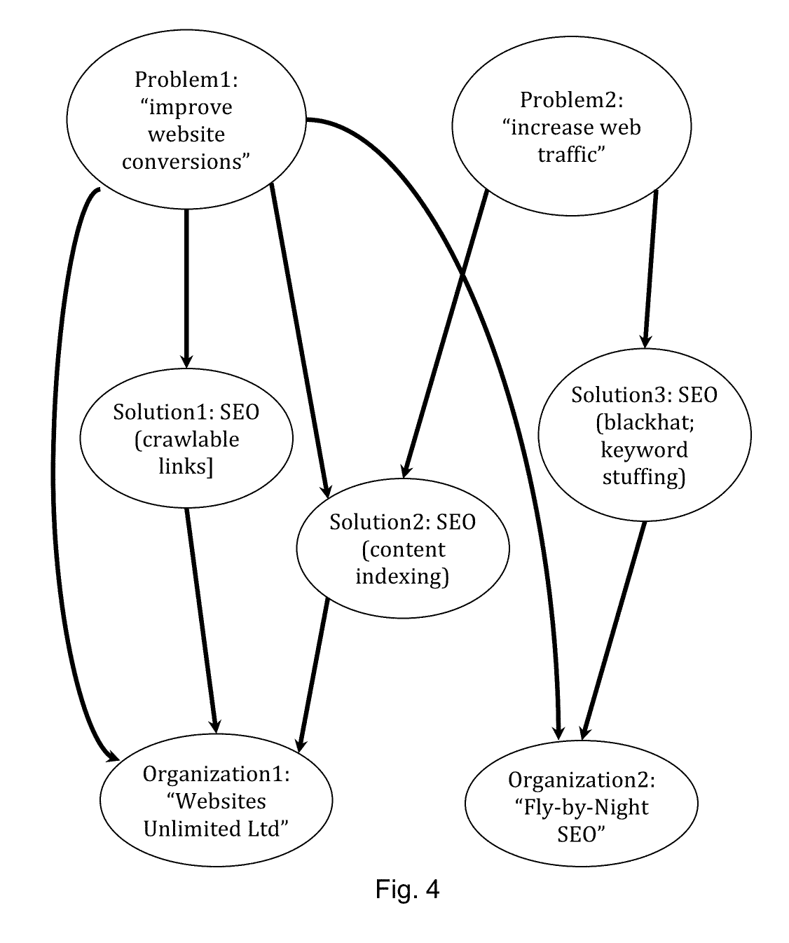

FIG. 4 shows a tripartite graph having ‘problem nodes,’ ‘solution nodes,’ and ‘organization nodes.’ The graph semantics provide three kinds of directed edges. A problem node is connected to one or more solution nodes by a “solved-by” edge (indicated by arrows). Inversely a solution node is connected to one or more problem nodes by a “solves” edge (not shown in FIG. 4). These problem-solution edges indicate that a problem can be (at least partly) solved by the solution connected thereto. Solution-organization edges indicate that a solution is offered by an organization (or experienced by a client organization). Problem-organization edges indicate that a problem has been solved by an organization (or experienced by a client organization). Note that these semantics allow for the case where an organization offers a solution and that solution can solve a problem, but the organization has no direct experience solving that problem. This is the case for organization 1, solution 2 and problem 2.

The search engine can traverse the graph to determine which vendor organizations provide which solutions to which problems. From the graph of FIG. 4, the search engine can determine that: two candidate problems match the buyer-user's query; there are three candidate solutions to these problems; and two candidate vendors provide some of these solutions. However the edges indicate that not all combinations are valid paths—vendors only provide a few solutions to a few problems.

In this example, Organization 1 provides two solutions (1, 2) but only solves one of the problems. Organization 2 does provide one solution but not to any problem that was user-selected. It provides solutions to different problems. In graph search terms, no problem node is connected both directly to Organization 2 AND indirectly via any solution node to Organization 2.

The system may provide the user with a UI to select from amongst the candidate solutions and problems in order to more precisely specify the desired problem-solution path and, ultimately, vendors to display. Thus from the user's text query, the user can confirm that Problem 1 was the problem intended and that Solution 1 seems like the better solution. Thus the search engine would return Organization 1.

The connections between problems and solutions may be associated with a problem-solution score to represent its popularity (or likelihood to solve). The system may calculate the scores from buyer-users selecting preferred problem-solution pairs and vendor-users entering their capabilities with regard to problem-solutions pairs. Thus the system learns which problems are solved by what solutions and a degree to which they are common. This score may be stored with the solved-by edge object between solution and problem nodes.

The problem object preferably includes data and keywords that provide a buyer-centric view in order to complement the vendor-centric view of the services and case studies, which solely make up existing directories. The present database may associate a bag of words or topic headers from a topic model with each problem node and each solution node. In order for a user to search the graph, the system first needs to transform the user's input into the space of problem or solution nodes. This transformation could be a information-retrieval system where the user's input is tokenized and each token is looked up in an inverted index, the postings of which refer to problem/solution nodes relevant to that token. A richer transformation would involve computing document similarity between the user's text input and “description” documents associated with each problem/solution node, in order to return the nearest nodes (with a limit to the number of nodes and/or the similarity distance to the nodes—that distance could be used to subsequently influence the rank of results in the graph search query). Document similarity could be as simple as cosine similarity in feature space, or it could transform documents into a topic space, using latent semantic analysis (LSA), latent Dirichlet allocation (LDA) or neural networks (e.g. Siamese networks). For efficiency, the topic-model transform could be pre-computed for all problem/solution nodes and those topics can be stored in a representation that allows for efficient nearest-neighbor retrieval (e.g., M-tree, binary space partition, location hashing).

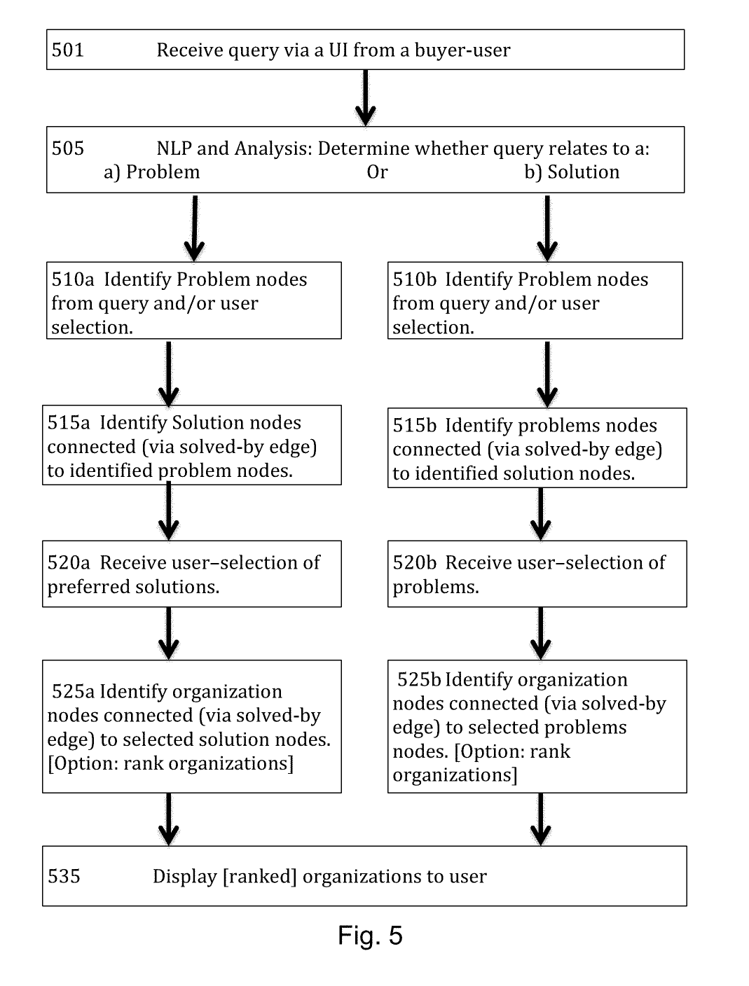

A method of matching a buyer to a vendor using a query and problem/solution nodes is shown in FIG. 5. The search engine receives a text query from a buyer-user, which query describes a problem to be solved or service to be provided (see 501). In 505, the search uses Natural Language Processing (NLP) to determine whether the query pertains to a problem or a solution. The NLP may include pre-processing such as spell-correction, stemming, and tokenization into words or n-grams.

Then the search engine may use feature modeling or topic modeling to compare the n-grams in the query to the n-grams associated with each problem node to identify a set of matching problems (in 510a). The probability that a problem matches the text query may be scored based on the degree of the feature/topic matching. The most likely problems may be shown to the user for selection.

The problem and solution nodes may also comprise a natural language description for display to the user. This could be an application of “automatic summarization” to the collection of description documents associated with all the problem/solution nodes.

The search engine identifies from the database which solution objects are connected by a solved-by edge to the matched (and preferably user-selected) problem objects. These solution objects may be displayed to the buyer-user to select their preferred solution methodology (see 515a and 520a). This can be seen as a search for nodes of a given type that are two-hops away from an identified problem node (or from an identified solution node).

In 525a the search engine searches the database for organizations that are connected to the identified solution objects, the connection object representing that the organization is a provider of that solution. The identified organizations are returned to the user as search results (535).

Preferably the search engine further limits the identified organization objects to those that are tripartite connected to the matching problem objects and selected solution objects, i.e. the organization node is connected to both a relevant solution object and a relevant problem object.

Thus for a text query that indicates a problem, the search engine traverses the graph in a directed way from problem to solution to vendors. The search engine may also be programmed to find vendors given a solution. Thus using different edge types, a path from solution node to problem node to organization node can be traversed (steps 510b, 515b, 520b, 525b). The UI may receive a query with regard to a solution. As discussed above, a solution is not necessarily a service, but rather a description of a methodology and/or results for solving a problem. The search engine may identify from the database one or more solution objects that match the query.

Step 505 may return probabilities that the text query intended a problem generally or a solution generally, in which case both graph paths are traversed. The step may also calculate probabilities that the text query indicates a particular problem or solution node. Using techniques discussed further below, this step may convert the text query into a 2D vector of nodes and probabilities, such as [Problem-first path, 55%; Solution-first path 45%; Problem 1, 25%; Solution 1 12%; . . . Problem 2 AND Solution 3, 5%; . . .]. Step 525a,b may score each vendor organization by summing scores for each path from query to that vendor, where each such path score is the joint probability of nodes along the path matching the query AND the probability that the path was even intended by the query. Thus a vendor scores 0.48 when found through a single problem node that is 60% indicated by the text query AND the problem-first-path (path ‘a’ of FIG. 5) was 80% intended by the text query. Additional joint probability may be considered given the probability of a solution node matching part of the text query. These probabilities are increased to 100% when nodes are positively confirmed by user-selection.

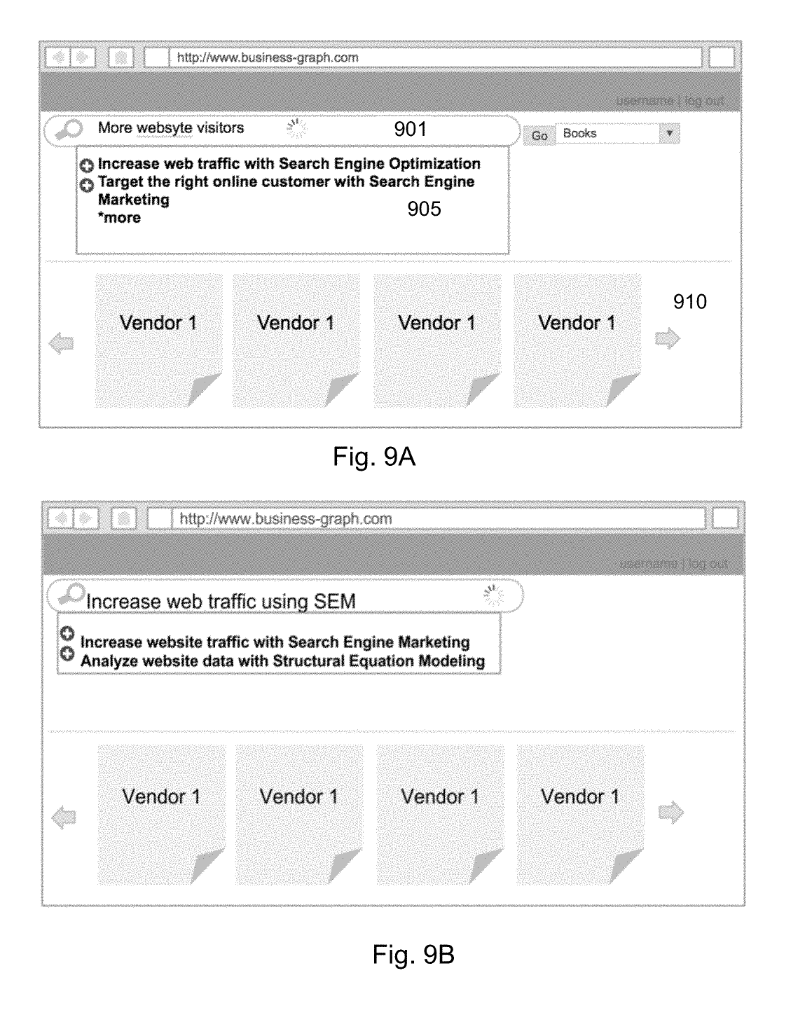

Potentially the query may be a complex query having both problem and solution features, as shown in FIG. 9B. Each auto-suggestion shown to the user represents a path connecting a specific problem node to a specific solution node. The NLP module may determine that the query features match features of problem and solution objects. The NLP module detects grammatical features in the query that identify separation of problem and solution features. For example, the complex query “Increase web traffic using SEO” syntactically resolves to: a problem node; a conjunction; and a solution node. The conjunction (such as with, using, by, and, &, semicolon, comma) helps to identify that there are two parts and that they are connected in the buyer's query and in the database.

The vendor organizations may be scored/ranked by the search engine in order to select certain vendors and order them for display to the user. The search engine may rank by number of paths that lead to the vendor object, which paths may include case studies objects, client objects, problem objects, and solution objects. Each of these paths provides context and support that the organization can meet the user's needs. For example, the path may proceed from problem node to organization node (as a client that has experienced that problem) to a case study node (where that client experienced that problem) to a solution node (whereby the solution solved that problem for that client) to the final (vendor) organization node to be returned. A representation of these paths with context and support may be displayed to the user.

The present database provides an opportunity to determine the degree to which a vendor is a specialist or generalist. The search engine may determine a specialist metric by considering the in-degree (i.e. how many edges directly connect into a organization node) from problem or solution nodes. The most specialized vendor has a high in-degree from user-selected problem nodes compared to the organization's in-degree from all problem nodes (or user-selected solution nodes and all solution nodes).

### Data Sources

The problem and solution data objects may be populated and connected in the database by users of the system via a UI displayed at client-computing devices. For example, vendor-users may log in and create a new solution object, providing text descriptions of the methodology and expected results. A client-user may log in and create a new problem object, providing text descriptions of a problem they have experienced and any background information. The problem or solution objects become connected to the relevant vendor and client organizations. Users may also connect their organization to existing problem or solution objects, as solving or experiencing that problem/solution. Users may also assert that a particular solution solves a particular problem. The system may create a connection between the problem and solution objects and calculate a connection score, based on the number of users that assert the connection between these objects.

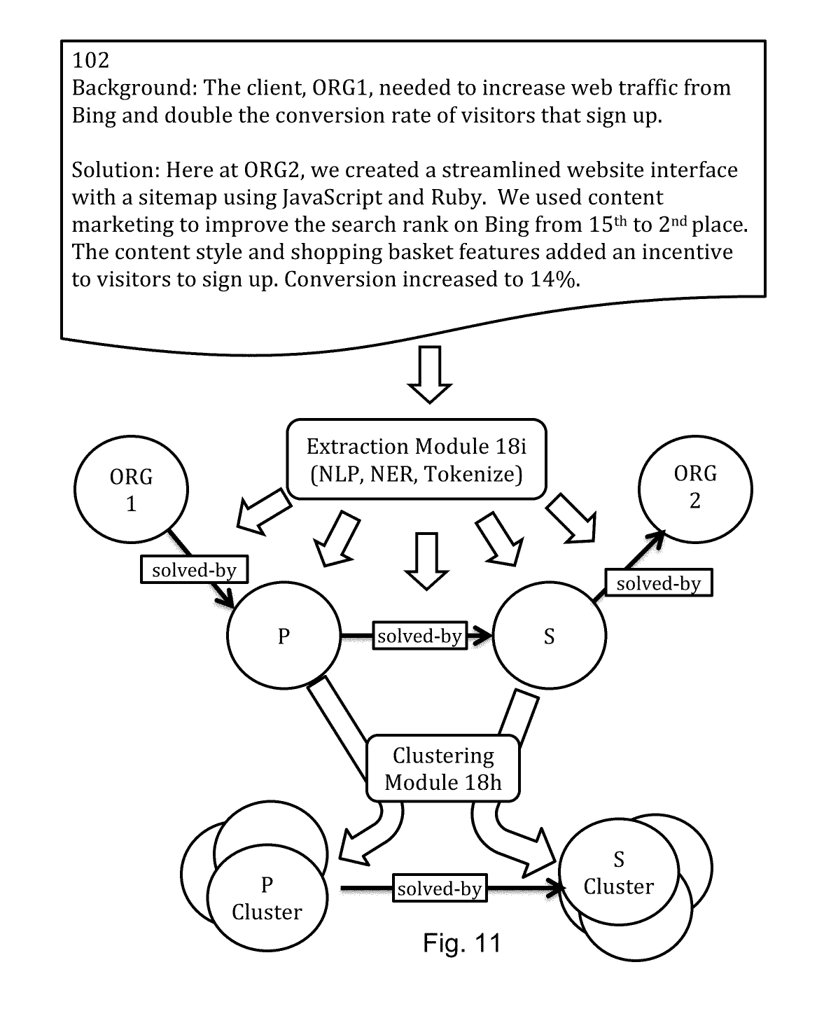

In an alternative embodiment, the system comprises a Machine Learning Module to populate the problems and solution objects in the database by extracting data from relevant electronic documents about business services. For example, the documents may be online trade journals or case studies in the database. The system may use NLP or machine learning techniques such as Convolutional Neural Nets, NER and/or Topic Modeling to extract features (e.g. keywords, entities, attributes and concepts). U.S. Ser. No. 14/877,573 filed 7 Oct. 2016, titled “Searching Evidence to Recommend Organizations incorporated herein by reference, provides further details on extracting such data. FIG. 11 illustrates case study 102 being extracted by the Extracting Module 18i to identify text features and relationship between features. The Module then creates problem (P) and solution (S) objects connected to each other (solved-by) and to organizations (ORG1, 2) connected to the case study.

Research has found that many case studies are formatted in one of several standard ways, tending to separate background/situation text corresponding to the problem and solution/methodology/result text corresponding to the solution. Using these section titles, the Extraction Module can extract the subsequent n-grams and interpret them as relevant to either problems or solutions. Named entities such as company names, industry names and service tags are further used by the Module to identify problem and solution sections and identify tags and organizations to connect. Service tags tend to appear in solution sections and industry descriptions tend to appear in the problem section. The features are added as features of the created objects.

To make the number of problems and solutions manageable, problems and solutions are each clustered by a Clustering Module 18h. Thus each solution node represents a set of similar, individual, real solutions. The clustering may be done using topic modeling, whereby a solution (or problem) node is represented by a distribution over text features that are most common to the set of associated individual solutions. See the bottom of FIG. 11. Alternatively clustering may be performed thru collaborative filtering to determine clusters of nodes that are selected by similar users.

After clustering to create problem and solution nodes, the Clustering Module 18h connects the nodes of organizations, case studies, and people to the problem and solution nodes comprising the individual problem/solution to which the node is associated. Thus many vendor organizations will all be connected to the same solution node, the node representing a plurality of similar solutions that individual vendors offer. The system may learn and assign cluster headers and NLG description for a given cluster from text entered by past users who then selected that problem (or solution) node (or cluster of problems/solutions). There will be many candidate headers and descriptions for each node but the Module may use the text most frequently entered.

### Receiving Unstructured Queries

Certain existing systems identify vendors that simply match some of the query keywords without capturing buyer-intent or service capabilities. The mere existence of the keyword match may be irrelevant and out of context.

Other known techniques use text queries for vendor searching by mapping the text to a service tag using a bag-of-words. This allows existing systems to map buyer keywords to the database and appear intelligent, but ultimately the search proceeds using the official tags and standard attribute values. In some cases, this works to align the buyer to what the database can provide but in many cases the buyer's intention, expectations and additional contextual information is lost when returning results.

For example, on existing systems, a simple query such as “file an invention in Europe” might be mappable through the bag-of-words approach to the services: ‘Trademark Filing’, ‘Patent Drafting’, ‘Patent Litigation’, ‘Engineering’, “CE Mark Filing” and ‘Product Launch Marketing’. Each of these services results in vendors that provide the selected service, even though some vendors do not address subtle aspects of the original query (such as being a European patent).

However, text entry boxes are still a user-friendly method of receiving a search query. Thus in preferred embodiment of the present system, a unstructured text query is interpreted using Natural Language Processing (NLP) to match query words to the most relevant data objects and to return search results that are connected to these matching data objects. The relevant data objects are intermediaries for the search results but still provide useful context.

As used herein, an unstructured query is simply a text string entered by a user that is unstructured with respect to the database structure and query language but may of course be structured with respect to a natural language (e.g. English grammar).

The system provides means for inputting a text string by a user operating a client-computing device. The means may be a text entry box within a User-Interface (UI) of a website. The user may enter text in natural language specifying a problem to be solved, services, or a connected organization, either named explicitly or using attributes such as locations and industries.

FIG. 9A illustrates a web interface for inputting a text query 901 and receiving autosuggestions 905 for a text search as well as the search results 910. As shown, the user has typed “More websyte (sic) visitors” and in response received a set of ranked autosuggestions. The search engine may process the text after each keystroke or when the user has pressed return. A set of vendors is displayed that match the selected query. Alternatively the results 910 may be provided immediately using the most likely intended query which is also displayed, with links to alternate candidate queries displayed for subsequent user-selection.

The autosuggestion and user selection process may also be iterative, wherein a user's text query results in suggestions of known problem or solutions. User selection of one of these problems (or solutions) leads to another iteration of suggesting solutions (or problems) connected to the selected problem. This process may be repeated until the user has optimized their selection of the problem and solution which then leads to search results.

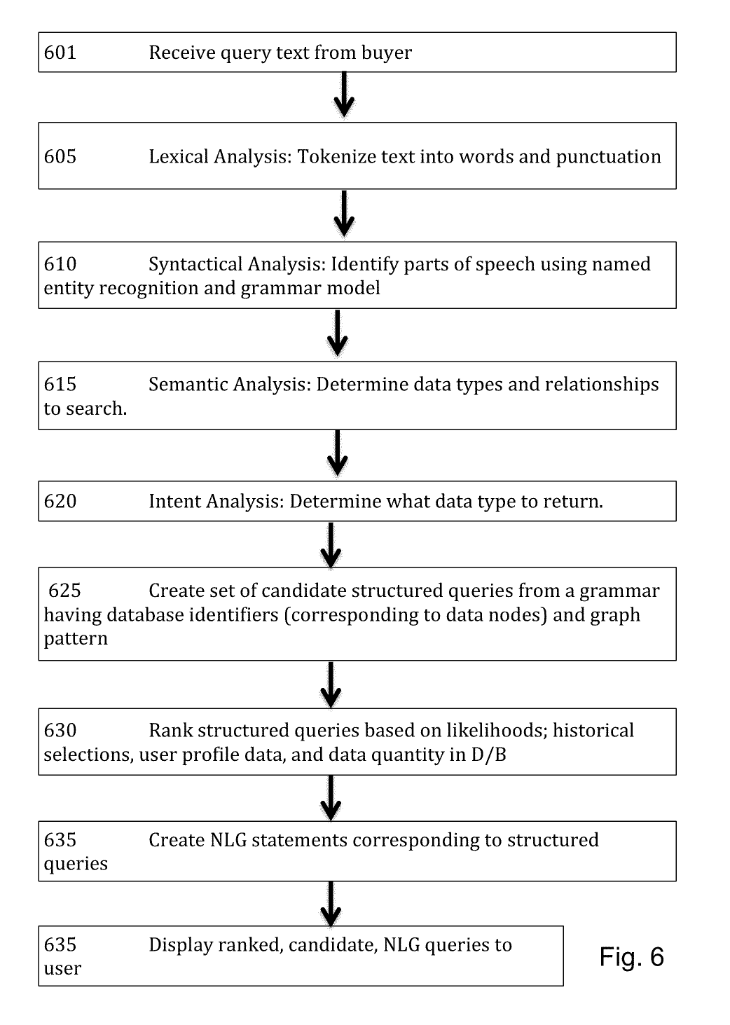

FIG. 6 provides a flowchart for processing a text string into a structured query, useful in autosuggestions. At 601, the server receives query text from a buyer-user. The search engine comprises an NLP module to process the text string, through instructions (or sub-modules) for tokenizing the text string into words (605), identifying parts of speech using Named Entity Recognition (NER) and a grammar model (610), determining the data types relationships to search (615), and analyzing user intent to determine what object(s) or object type(s) type to return. At 625, the search engine creates one or more structured queries to run on the database, the structured query having a) identifiers corresponding to data objects and b) patterns representing the relationship between objects and form of search results. These queries may be ranked based on calculated likelihoods, historical selections by users, and quantity of data in the database that supports each candidate query.

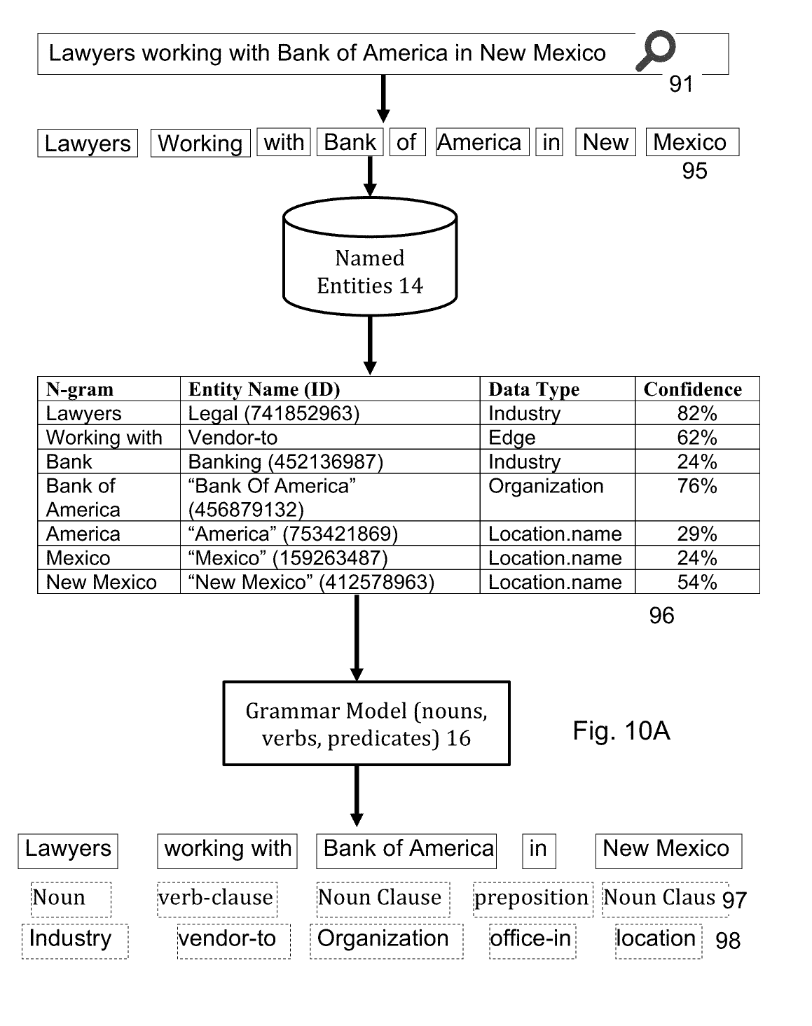

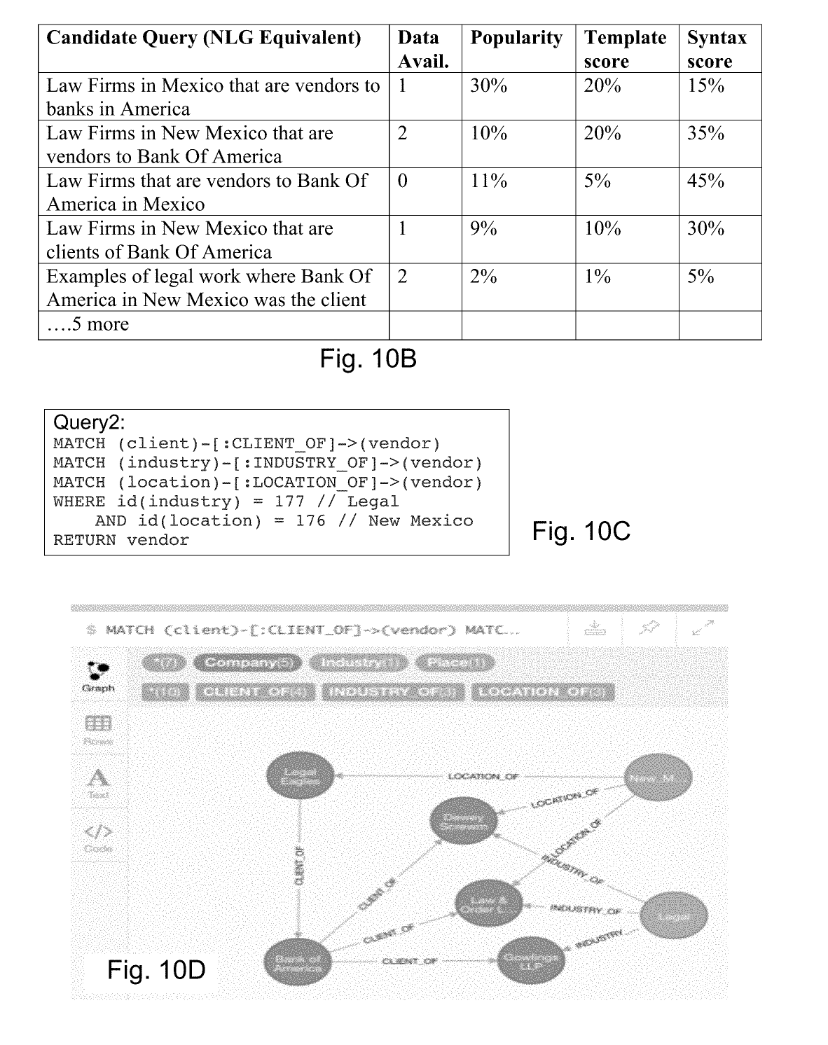

The NLP technique is exemplified in FIG. 10A with an example string 91 received at the web server. The string is tokenized into nine words 95 by identifying white space and hyphenated words. A NER module looks-up the words (as N-grams) in a database (such as index 14) of known entities, including company names, industry names, city names and names of data object types, such as node types or edge types. From the comparison, the systems assigns the words to one or more known entities (Table 96), each with an entity confidence score. The NER Module identifies the formal entity name, data type, and confidence that the n-gram refers to the named entity Preferably these confidence scores are compared to a threshold to discard entity assignments less than a threshold score. In some cases, there will be outstanding ambiguity regarding which entity a word refers to.

These words or entities are assigned a part-of-speech using the grammar model 16. The grammar model 16 determines the relationship between words/entities and determines the intention of the buyer's query. In particular, the grammar model considers the order of n-grams that are entities and their position relative to n-grams that are not entities, which may act as predicates, verb clauses or prepositions. The bottom of FIG. 10A shows the NLP interpretation of the query (91) using a context-free (97) and a service-context grammar (98).

The grammar model is preferably created within a service-context, preferably with respect to the present business-graph structure and preferably with biases towards interpreting the text string as a search for finding vendors. Certain ambiguities can be resolved by rules in the grammatical model that dictate what relationship one data object can have with another. For example, the n-gram “performed by” might be assigned to edges of several possible types but the grammar rules indicate selecting such edges that exists between a specific first node type (e.g. case study) and a second node type (e.g. organization), being selected over a different second node type (e.g. person).

FIG. 10B illustrates candidate queries that might correspond to the user's query. Each candidate query is run on the graph to identify the data available to support that query; the popularity of the candidate query from historical use, both for the particular query (e.g., ‘Law Firms in New Mexico that are vendors to banks in America’) and for other queries that follow the same pattern (e.g., ‘<service> firms in <state> that are vendors to <industry> in <country>’)” and the syntactical likelihood that the structured query corresponds to the user's query.

Finally, a structured query is generated comprising a set of graph node identifiers and path dependence. FIG. 10C is an example query, shows in the Cypher language on a Neo4j graph database, corresponding to the second candidate query of FIG. 10B. FIG. 10D illustrates a portion of the data objects involved in the query of FIG. 10C. A first set of organizations is identified using a “client-of” index starting from the organization node 456879132, corresponding to “Bank of America.” A second set of organizations is identified using the “location-of” index from the location 412578963 (“New Mexico”) and a third set using the “industry-of' index from 741852963 (”Legal“). The search engine identifies the intersection of these three sets to return the two organizations: Dewey Screwm and Law&Order LLP.

The structured search query includes first elements relating to Node Ds and second elements related to query patterns.

### Disambiguation

The search engine may generate and rank a plurality of structured queries from the user's text string. In many cases, there will be a plurality of structured queries of similar likelihood using NLP alone. This may be because the n-grams match many data objects or the text string does not comport well with the grammar model, making the query ambiguous. For example, a text string may contain an ambiguous relationship between two entities and an adjective (e.g. attribute value) that might modify either entity (e.g. “Accountants working with lawyers Seattle”). The search engine may determine that there are four candidate queries—business relationships in either direction between the entities and either entity having that location value. The search engine may disambiguate this in several ways.

In a first embodiment, the search engine returns the set of ranked queries to the user device for the user to select from. The user may select more than one query, in which case all selected queries are run and the final results may be an aggregated or separated by selected queries. In the above example, four candidate queries may be displayed to the user as autosuggestions or as groups of intermediate results, from which final results may be selected by the user.

In a second embodiment, the search engine runs the plurality of candidate queries on the database. The aggregated results may be returned to the user device as query results or the engine may further rank and disambiguate the candidate queries based on whether and how many results are returned by each. In the above example, the search engines tries all four queries and determines that two queries return no results, one query returns only one result, and the last query returns many results. This post-facto analysis might imply that the user intention was for the last query and thus only these results are returned to the user device (E.g. “Accountant firms W, X, Y, and Z provide services to law firms that are in Seattle”).

In a third embodiment, the search engine compares the ambiguous candidate queries to previous queries which were not ambiguous or which were successfully disambiguated. The search engine may rank the current candidate queries based on the popularity of and similarity to the previous queries. Previous queries may be stored in a second data store, each previous query object comprising a popularity score, keywords used, the pattern of the query (data object types, connection types and their order in the text string) and the structure query. In the above example, the search engine searches for previous queries that had similar n-grams and a similar pattern, to determine a query similarity score which is multiplied by the popularity score. For the above example, the search engine might learn over time that a text string of the pattern: ‘industry 1,’ edge, ‘industry 2,’ ‘city 1,’ most commonly resolves to the pattern (in NLG terms): “show companies of Industry 1 that are service providers to companies of “industry 2” that have location attribute ‘city 1.’ Alternatively in set theory terms: {c1|c1 ∈ C [symbol] |(c1, i1) [symbol] ∃c2∈C (V(c1, c2) [symbol] |(c2, i2) [symbol] P(c2, L1))} where C denotes the set of organizations, i1 denotes industry 1, i2 denotes industry 2, L1 denotes location 1, L(x, y) indicates company x belongs to industry y, V (x, y) indicates company x is a vendor to company y, and P(x, y) indicates company x is located in location y.

In a fourth embodiment, the search engine compares the ambiguous candidate queries to a set of query templates. These query templates may be a pre-defined table used to map query tokens to a structured search query. Each query template preferably includes an ordered list of data object types having a particular syntax. The query templates may include wildcards within the list, order variance for certain objects, and optional objects. The particular syntax may include prepositions, clauses and surrounding words that give the object a meaning in that query format. The search engine compares the tokenized query with each of the template query to select the most similar template query and then uses the structured graph query associated with it. Each template query may also be associated with a popularity score to represent how common that format is. The query formats that are the most popular and most similar to the user's query are selected by the search engine. Advantageously this enables the search to be optimized for the most common user queries in terms of speed, user intention, weighting and precision of results.

In the above example, the tokenized query has the following ordered object types and verb clauses: industry, verb-clause, industry, city. The search engine may determine using template matching that the closest query format is: wildcard, industry, verb-clause, industry, verb-clause, city, [country]. The search engine then runs the associated structured query.

These embodiments may be combined to rank candidate structured queries using multiple scores. The table in FIG. 10B includes probability scores for data availability (second embodiment), user popularity (third embodiment) template similarity (fourth embodiment), and syntax likelihood (with respect to the grammar model). The skilled person will appreciate that there are many ways to combine such scores, such as using a weighted sum, diminishing returns, thresholds, or Boolean operators.

### Natural Language Generation

The system's interpretation(s) of the unstructured text string may be fed back to the user using Natural Language Generation (NLG). An NLG Module 18L may compile a second text string which corresponds to how the NLP Module has interpreted the user's text string per the structured query. Given the template matching above, NLG Module 18L may plug equivalent words into the query template having a template NLG statement. This feedback enables the user to correct the unstructured queries or select from a candidate set of structured queries. The NLG module may use the same grammar model or another grammar model to convert the structured query or the original unstructured text string into an equivalent text string.

For example, identified data objects are replaced with user-friendly text, such as a name or short description. For example, a particular node ID may be replaced with the node name (e.g. company name, case study title, award name). A particular edge ID may be replaced with the edge name (e.g. “client of”) or prepositions (e.g. “in,” “of”). An object type may be replaced with the name of or common attribute of the object type (e.g. “companies” to be general or “American automotive companies” to be more specific). Attribute IDs and Location IDs are converted to the commonly understood location name (e.g. city, state). The interpreted intention of data to return can be converted by the NLG module to the corresponding intention text (e.g. “what are the . . . , ” “show examples of . . . , ” “what vendors provide . . . and “what cities . . . ”).

Certain elements of the structured query relate to Boolean logic, how the database should be traversed or how the data should be aggregated. Certain of these elements can be replaced with text (e.g. “AND” “OR”) through the grammar model but others might not be converted, as they are not understandable to a lay user.

The table of FIG. 10B contains NLG statements equivalent to candidate structured queries, wherein the second statement corresponds to the query of FIG. 10C.

The result is one or more NLG sentences to be communicated to the client-computer. The NLG sentence(s) may exactly match the user text string but in many cases, will be altered to reflect the data available and the data structure used.

### Running Structured Queries

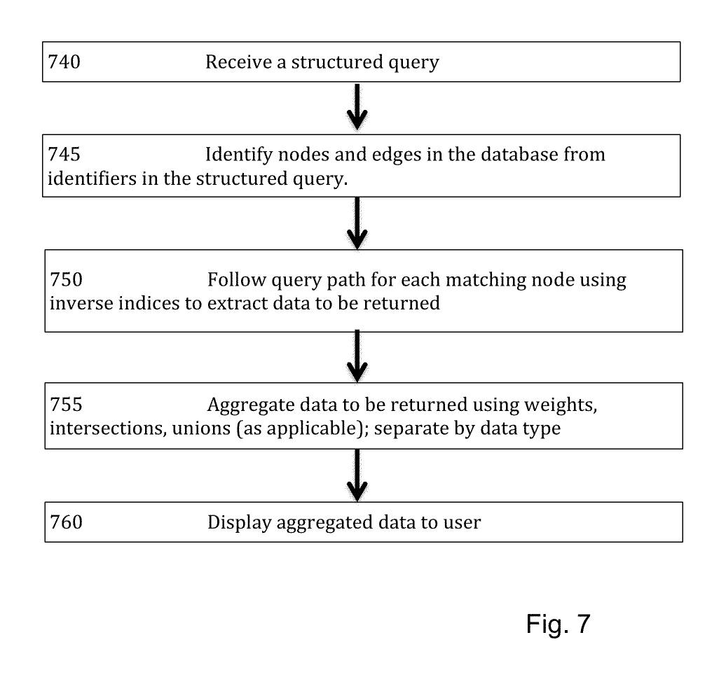

FIG. 7 is a flowchart for running one of the structured queries on the database. At 740, the Query Module 18j of the Search Engine receives a structured query (either selected by the user or the search engine). At 745, the Query Module identifies data objects in the database from the identifiers in the structured query. The identifiers may point to a particular node, a node type, or an attribute for identifying nodes. Similarly, the identifiers may indicate a particular edge, an edge type, or an attribute for identifying edges. The structured query may further include database query patterns, such as directions to traverse the database, starting nodes, terminal data to be returned, Boolean logic operators, fuzzy logic operators, and methods to combine results (such as intersection or union).

At 750 the Query Module traverses the graph, following a path from each identified node along the identified edges to reach a terminal node of the type to be returned as search results. The Query Module may use inverse indices of the identified edge to find return objects given the starting objects.

At 755, the terminal nodes are combined to create a set of results. Relevant data of each terminal nodes may be retrieved and aggregated, preferably aggregated by the type of nodes connected thereto. Preferably, the edge type to these other nodes is also used in segregating and aggregating these other nodes connected to the terminal nodes. For example, for a vendor in the results, the number of its relevant case studies that are connected to that vendor by a ‘solved-by’ edge are counted (and similarly for number of its relevant clients, number of its solution nodes connected to the starting problem node).

In many structured query languages, a declarative query is sent to the query compiler stating the objects to be returned and the conditions of those objects. The actual implementation of the database traversal is at the discretion of the query compiler in order to optimize for speed and database size.

### Indexing

To reduce real-time computation delays, the database may be indexed in ways to retrieve objects most commonly associated with certain objects. For example, problems may be indexed in order of popularity and each problem object may be associated with an index of solutions ordered by likelihood to solve the problem (or popularity of the solution for that problem).

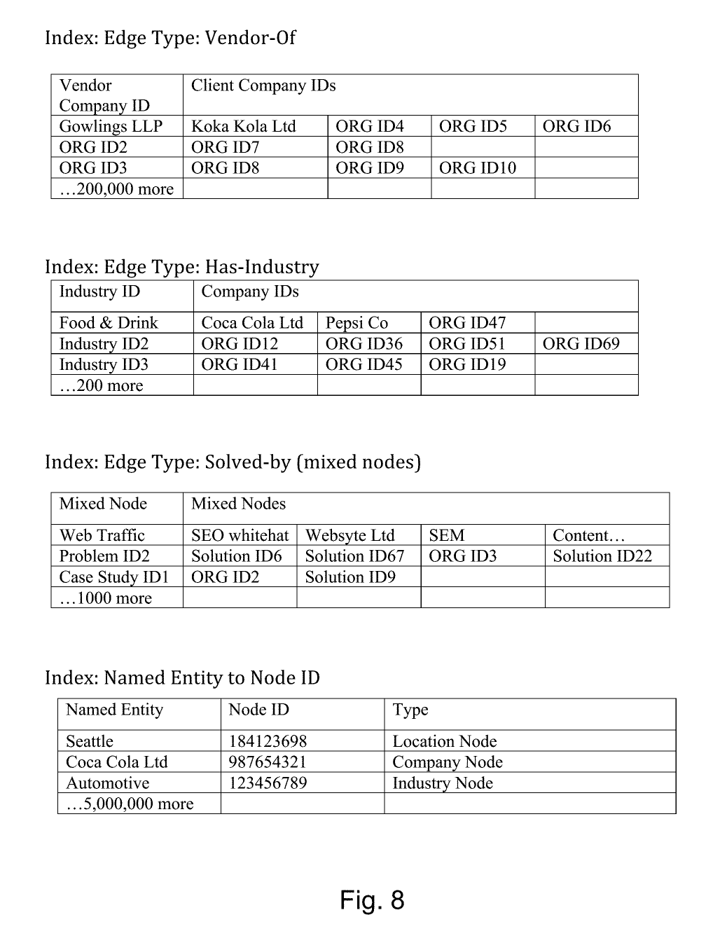

FIG. 8 illustrates exemplary indices to identify node IDs via an edge type given a node ID or named entity. The indices typically use node IDs (e.g. UUIDs) but in FIG. 8 some exemplary entries are shown as named entities for ease of understanding. In FIG. 8, the left column represents a value to lookup and the right column(s) represent the value(s) to return. The first index shown provides the connection from a first organization to a second organization corresponding to the edge of type “vendor-of.” The second table connects industry values to organizations using the has-industry edge. The third table provides an example of how the generic edge “solved-by” provides a connection between first nodes of various types to second nodes of various types, representing that the second nodes in some sense solve an aspect of the first nodes.

The indices provide a fast way to retrieve a data object given a starting node and connection type, both provided by tokens in the structured query. For example, given the query tokens 1) edge type is “Has-industry” and 2) node industry is “Food & Drink” the index of FIG. 8 provides three matching Organizations (or more precisely their UUIDs).

The fourth index is used by the NER Module to identify a node ID and its node type given an n-gram from the text query. This index indicates which nodes contain this n-gram. This may be a simple lookup table, the NER Module optionally using normalization, tokenization or heuristics to determine which entity to choose when the input n-gram matches (or nearly matches) multiple known entities.

A transitive closure matrix may be stored in the database to store the number of direct and indirect paths between vendors, problems and solutions. The search engine may lookup a given problem to determine which vendors solve that problem and via how many paths in the graph. The number of paths provides a quick metric for the evidence for this vendor-problem connection, as stored in the full graph.

### Display

The system receives queries and communicates results to users via a user interface on the user's computing device. The system prepares web content from the first object (e.g. vendor) and second objects (e.g. evidence and path-dependent context). A Serialization Module serializes the web content in a format readable by the user's web browser and communicates said web content, over a network, to a client-computing device 10.

Display to a user of a vendor means identifying names, features and attributes from a vendor object in the database for consumption by the user. Display of a case study object may similarly be made by displaying the text from the document or a multi-media file (e.g. JPEG, MPEG, TIFF) for non-text samples.

The above description provides example methods and structures to achieve the invention and is not intended to limit the claims below. In most cases the various elements and embodiments may be combined or altered with equivalents to provide a recommendation method and system within the scope of the invention. It is contemplated that any part of any aspect or embodiment discussed in this specification can be implemented or combined with any part of any other aspect or embodiment discussed in this specification. Unless specified otherwise, the use of “OR” and “/” (the slash mark) between alternatives is to be understood in the inclusive sense, whereby either alternative and both alternatives are contemplated or claimed.

Reference in the above description to databases are not intended to be limiting to a particular structure or number of databases. The databases comprising documents, projects, business relationships or social relationships may be implemented as a single database, separate databases, or a plurality of databases distributed across a network. The databases may be referenced separated above for clarity, referring to the type of data contained therein, even though it may be part of another database. One or more of the databases and agents may be managed by a third party in which case the overall system and methods or manipulating data are intended to include these third-party databases and agents.

For the sake of convenience, the example embodiments above are described as various interconnected functional modules. This structure is not necessary, however, and these functional modules may equivalently be aggregated into a single logic device, program or operation. In any event, the functional module can be implemented by themselves, or in combination with other pieces of hardware or software.

While particular embodiments have been described in the foregoing, it is to be understood that other embodiments are possible and are intended to be included herein. It will be clear to any person skilled in the art that modifications of and adjustments to the foregoing embodiments, not shown, are possible.

For further understanding of the technology above, reference is made to the following documents:

Hamdi, M. (2015). Statistical signal processing on dynamic graphs with applications in social networks (T). University of British Columbia. Retrieved from https://open.library.ubc.ca/clIRcle/collections/24/items/1.0223171.

Patent U.S. 62/352,989 filed on 21 Jun. 2016 titled “System and Method for Connecting Objects in a Business Database.”

Patent U.S. Ser. No. 14/690,325 filed on 17 Apr. 2015 titled “Influential Peers.”

1. A computer-implemented method comprising:
providing a graph comprising problem nodes representing business problems, solution nodes representing business solutions, and organization nodes representing organizations;
receiving a search query about a business problem from a user device;
matching the query to one or more problem nodes in the graph;
identifying solution nodes connected in the graph to matched problem nodes;
identifying organization nodes connected in the graph to identified solution nodes; and
communicating data about certain of the identified organization nodes to the user device, as query results.

2. The method of claim 1, wherein the search query is an unstructured text query.

3. The method of claim 2, further comprising creating one or more structured queries from the unstructured text query, the one or more structured queries comprising identifiers of problem nodes and solution nodes.

4. The method of claim 1, further comprising communicating to the user device a set of Natural Language Generated suggestions from candidate problem and/or solution nodes identified from the query.

5. The method of claim 1, further comprising receiving a selection of one or more of the Natural Language Generated suggestions from the user device to indicate a user preference for corresponding business problems or business solutions.

6. The method of claim 5, where the identified organization nodes are connected to the problem and/or solution nodes corresponding to the selected problems and/or selected solutions.

7. A computer-implemented method comprising:
providing a database arranged as a graph of business relationships between organizations;
receiving an unstructured query from a user device;
creating one or more structured graph queries from the unstructured query, using a Natural Language Processing (NLP) process, wherein each structured graph query comprises an identifier of second nodes connected by edges to one or more first nodes to be returned as search results, the nodes and edges representing a context for a provision of professional services related to the unstructured text query; and
running the one or more structured graph queries on the graph to return search results to the user device, which results comprise data from the first nodes.

8. The method of claim 7, wherein at least one of the first or second nodes represent organizations providing the professional services

9. The method of claim 8, wherein the other of the first or second nodes represents one of: a document, a case study, a person, a solution, a problem or another organization.

10. The method of claim 7, the NLP process using Named Entity Recognition and a grammar to determine from the unstructured search query, identifiers of nodes and edges and a graph query pattern.

11. The method of claim 7, wherein the graph further comprises nodes representing one or more of: case studies; employees, problems, and solutions.

12. The method of claim 7, wherein the NLP process creates the structured graph queries from template queries.

13. The method of claim 7, further comprising ranking the one or more structured graph queries based on at least one of: similarity of one or more corresponding template queries to the unstructured query; the amount of data in the graph that supports each structured graph query; similarity of each structured graph query to structured graph queries that were previously selected.

14. The method of claim 7, wherein the NLP process identifies organization names, location names, industry names or service names in the unstructured text query that match entries stored in a named-entities database.

15. The method of claim 7, wherein the results returned are organizations that provide a professional service.

16. The method of claim 7, further comprising aggregating data of the search results, preferably aggregated by the type of second node.

17. The method of claim 7, further comprising creating clusters of first or second nodes by their attributes; receiving a selection of a cluster from the user device; and
displaying search results based on the selection.

18. A computer system comprising:
a database arranged as a graph of business relationships between organizations;
an interface for receiving an unstructured query from a user;
a search engine for
processing the unstructured query into words and parts of speech;
creating one or more structured graph queries comprising graph identifiers and a graph query pattern; and running the structures graph queries on the graph to return first nodes as search results; and
a communication process for providing the search results to the user.

19. Wherein the search engine comprises a Natural Language Understanding module, Named Entity Recognition module and a grammar model.

20. Further comprising a ranking process for ranking the nodes in the search results depending on the number of paths in the database to each node found using the one or more structured graph queries.
